(19) United States
(12) Patent Application Publication
(10) Pub. No.: US 2007/0192119 A1
(43) Pub. Date: Aug. 16, 2007

(54) Deliberation request allocation system, deliberation request allocation program, and deliberation request allocation method

(75) Inventor: Takao Akai, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/498,746

(22) Filed: Aug. 4, 2006

(30) Foreign Application Priority Data
Feb. 10, 2006 (JP) 2006-033974

(51) Int. Cl. G06Q 10/00; G05B 19/418; G06F 15/173

(52) U.S. Cl. 705/1; 705/8; 709/225; 709/226

(57) ABSTRACT

There is disclosed a deliberation request allocation system, deliberation request allocation program, and deliberation request allocation method, which are capable of calling all the divisions that are related to a standard to a deliberation, when a new standard is established or an existing standard is revised. The system comprises: a state-of-use obtaining section 1 that obtains, as electronic data, a state of use including users of the standard and the numbers of uses of the standard; a use result calculation section 4 that calculates a use result of the standard, by use of electronic data, based on the state of use obtained by the state-of-use obtaining section 1; and a deliberation request allocation section 6 that decides and allocates a party deliberation request target, who should attend a deliberation to revise the standard or to establish a new standard similar to the standard, by use of electronic data, based on the use result calculated by the use result calculation section 4.

### BACKGROUND OF THE INVENTION

1. Field of the Invention

The present invention relates to a deliberation request allocation system, deliberation request allocation program, and deliberation request allocation method for automatically allocating a corresponding deliberation division (or deliberator) to a request for establishment of a new standard or revision of an existing standard.

2. Description of the Related Art

Conventionally, establishment and revision of a general standard is carried out in a procedure as follows.

### 1) Drafting

A division who needs a standard prepares a draft.

### 2) Deliberation about Establishment

A drafting division and a utilization division who uses the standard deliberates contents of the drafted standard. At this time, the drafting division selects the utilization division.

### 3) Establishment/Publication

A management division actually establishes the standard. At this time, supplementary items such as relevant standards are added and distributed to the utilization division or published on the web or the like.

### 4) Revision Deliberation

After elapse of a predetermined period, the drafting division and the utilization division deliberate again to maintain information fresh.

### 5) Revision or Repeal

In case of revision, the new revision is provided for the utilization division or published on the web or the like. In case of repeal, the utilization division is informed of the repeal. In principles, the revision deliberation continues and revision is repeated until repeal is carried out.

Known as a technique relevant to prior art of the present invention is a decision support system to achieve efficient decision making based on information in a database (for example, see Patent Document 1: Jpn. Pat. Appln. Laid-Open Publication No. 5-298331).

Useful technical information such as standards should be shared widely as long as security requirements are satisfied. Therefore, such useful technical information is subjected to publication through the web or the like. This, however, causes a problem as follows.

After elapse of a predetermined period from establishment of a standard, revision of the contents is deliberated (revision deliberation). However, grasping of all utilization divisions is so difficult that several divisions are left not called for the deliberation. For example, the utilization division who has been expected from the initial stage of establishment has been grasped well in advance, and can be called for the revision deliberation. However, other divisions that have started use of the standard after publication on the web are grasped with difficulties, and cannot be called for the revision deliberation in some cases. In such cases, revision cannot be adjusted to fit actual circumstances even through the revision deliberation.

### SUMMARY OF THE INVENTION

The present invention has been made to address the problems as described above, and provides a deliberation request allocation system, deliberation request allocation program, and deliberation request allocation method, which are capable of calling all the divisions relevant to a standard to a deliberation to establish a new standard or to revise an existing standard.

To solve the above problems, the present invention adopts a management/disclosure system based on user authentication to manage standards. A state of use (the user, the number of uses, the division, etc.) of the standard is recorded, and a use result is calculated. Based on this use result, a deliberation division is automatically allocated and given a deliberation request.

According to an embodiment of the present invention, there is provided a deliberation request allocation system comprising: a state-of-use obtaining section that obtains, as electronic data, a state of use including users of a standard and the numbers of uses of the standard; a use result calculation section that calculates a use result of the standard, by use of electronic data, based on the state of use obtained by the state-of-use obtaining section; and a deliberation request allocation section that decides and allocates a party to be given a deliberation request, who should attend a deliberation to revise the standard or to establish a new standard similar to the standard, by use of electronic data, based on the use result calculated by the use result calculation section.

The deliberation request allocation system may further comprise a determination section that determines whether the standard should be frozen without a deliberation or not, based on the use result calculated by the use result calculation section.

The deliberation request allocation section may weight a deliberation right of the party to be given a deliberation request, based on the state of use.

The use result calculation section may regard, as the use result, a total of the numbers of uses by all of the users, the numbers of uses being included in the state of use.

The use result calculation section may weight the users, calculates weighted numbers of uses by the users, respectively, and may regard a total of the weighted numbers of uses, as a use result.

The deliberation request allocation system may further comprise a deliberation request section that sends an attendance request for the deliberation, to the party to be given a deliberation request, who has been allocated by the deliberation request allocation section.

The deliberation request allocation section may obtain user information from a user information management database that manages user information including the users, and may let the party to be given a deliberation request correspond to a destination address of the obtained user information.

According to another embodiment of the present invention, there is provided a deliberation request allocation program that makes a computer execute allocation of a deliberation request, comprising: a state-of-use obtaining step that obtains, as electronic data, a state-of-use including users of a standard and the numbers of uses of the standard; a use result calculation step that calculates a use result of the standard, by use of electronic data, based on the state of use obtained by the state-of-use obtaining step; and a deliberation request allocation step that decides and allocates a party to be given a deliberation request, who should attend a deliberation to revise the standard or to establish a new standard similar to the standard, by use of electronic data, based on the use result calculated by the use result calculation step.

The deliberation request allocation program may further comprise a determination step that determines whether the standard should be frozen without a deliberation or not, based on the use result calculated by the use result calculation step.

The deliberation request allocation step may weight a deliberation right of the party to be given a deliberation request, based on the state of use.

The use result calculation step may regard, as the use result, a total of the numbers of uses by all of the users, the numbers of uses being included in the state of use.

The use result calculation step may weight the users, calculate weighted numbers of uses by the users, respectively, and regard a total of the weighted numbers of uses, as a use result.

The deliberation request allocation program may further comprise a deliberation request step that sends an attendance request for the deliberation, to the party to be given a deliberation request, who has been allocated by the deliberation request allocation step.

The deliberation request allocation step may obtain user information from a user information management database that manages user information including the users, and may let the party to be given a deliberation request correspond to a destination address of the obtained user information.

According to yet another embodiment of the present invention, there is provided a deliberation request allocation method in which a computer of a deliberation request allocation system is made execute allocation of a deliberation request, comprising: a state-of-use obtaining step that obtains, as electronic data, a state of use including users of a standard and the numbers of uses of the standard; a use result calculation step that calculates a use result of the standard, by use of electronic data, based on the state of use obtained by the state-of-use obtaining step; and a deliberation request allocation step that decides and allocates a party to be given a deliberation request, who should attend a deliberation to revise the standard or to establish a new standard similar to the standard, by use of electronic data, based on the use result calculated by the use result calculation step.

According to the present invention, when a new standard is established or an existing standard is revised, all the divisions that are related to the standard can be called for a deliberation. The deliberation thus becomes more meaningful. Accordingly, effective use of the standard can be achieved.

### BRIEF DESCRIPTION OF THE DRAWINGS

FIG. 1 is a block diagram showing an example of a deliberation request allocation system according to an embodiment of the present invention;

FIG. 2 is a table showing data in a state-of-use record DB;

FIG. 3 is a flowchart showing operation of the embodiment according to the present invention;

FIG. 4 is a table showing data which a use result calculation section deals with;

FIG. 5 shows a deliberation request allocation table; and

FIG. 6 is a table showing an example of calculating a use result by use of weights.

### DETAILED DESCRIPTION OF THE PREFERRED EMBODIMENTS

An embodiment of the present invention will now be described with reference to the drawings.

FIG. 1 is a block diagram showing the embodiment of the present invention. A deliberation request allocation system 100 has a state-of-use obtaining section 1, a state-of-use record DB (database) 2, and a user information management DB (database) 3. The state-of-use obtaining section 1 obtains a state of use (the user, the number of uses, the division, etc.), from access information concerning access made to a standard operation server 200 or the like to use a standard from the terminal installed at each division. The state-of-use record DB 2 records the state of use obtained by the state-of-use obtaining section 1. The user information management DB 3 manages user information of a user who uses a standard.

The deliberation request allocation system 100 has a use result calculation section 4 and a standard revision determination section 5. The use result calculation section 4 receives a standard number of a standard from a standard number input section 9, and an instruction on execution of revision of the standard number input section 9. Then or at predetermined timing, the use result calculation section 4 reads a state of use from the state-of-use record DB 2, and calculates a use result of the standard. The standard revision determination section 5 determines whether the standard should be revised or not based on the use result calculated by the use result calculation section 4.

Further, the deliberation request allocation system has a deliberation request allocation section 6 and a deliberation request section 7. If the standard revision determination section 5 determines that the standard should be revised, the deliberation request allocation section 6 decides and allocates a party to be given a deliberation request, by use of electronic data, on the basis of a state of use read from the state-of-use record DB 2 and user management information read from the user information management DB 3. The deliberation request section 7 sends a deliberation request by an electronic mail to the party (user) to be given a deliberation request, who has been allocated by the deliberation request allocation section 6.

Various standards are registered in a standard database (DB) 201 in the standard operation server 200. For example, standards are classified into major categories such as common standards, clerical standards, drawing standards, design standards, work standards, and the like. Each major category is subdivided into sub-categories, e.g., drawing design standards, installation design standards, wiring standards, circuit design standards, thermal design standards, and the like, which are provided as the sub-categories below the major categories.

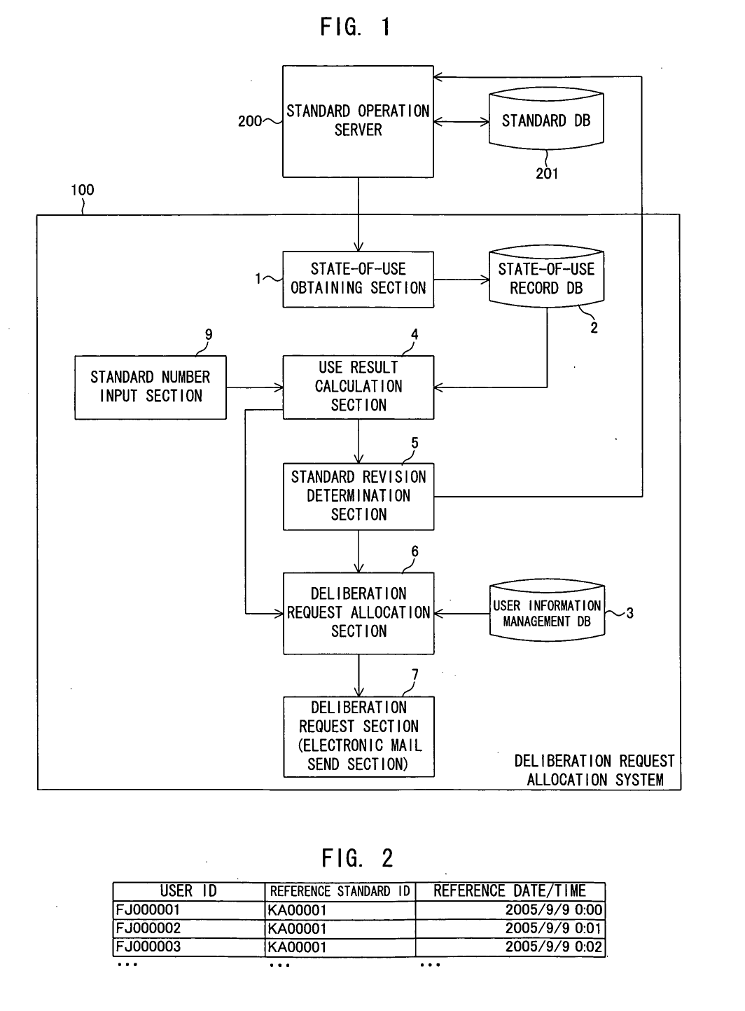

Standard IDs are assigned respectively to the standards described above from the major categories to the sub-categories. When a user accesses the standard operation server 200 to use a standard, the user ID of the user, a standard ID, and access date/time referred to are obtained by the state-of-use obtaining section 1 and are recorded into the state-of-use record DB 2, as shown in FIG. 2.

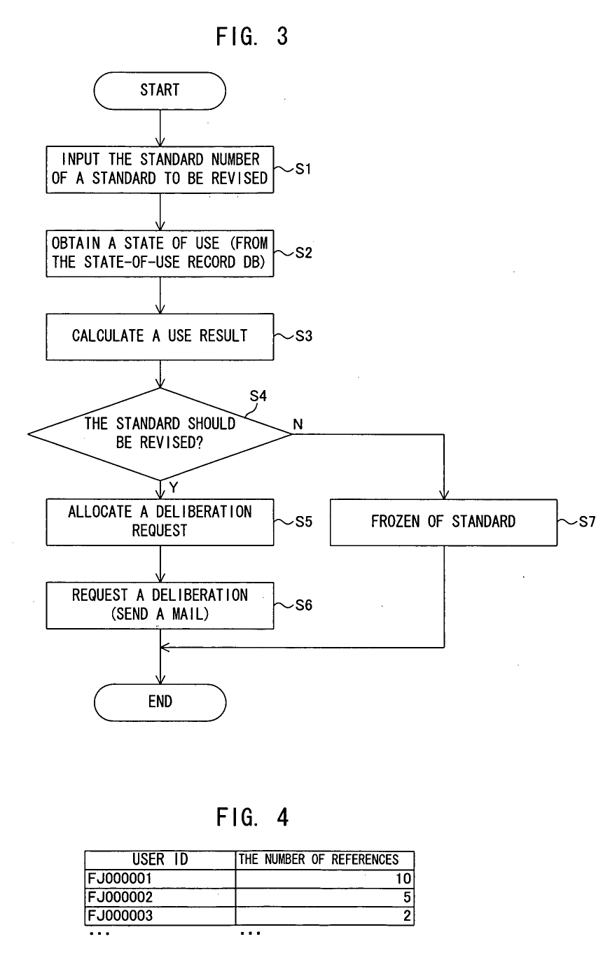

Next, operation of the embodiment of the present invention will be described along the flowchart shown in FIG. 3.

For example, if the drafting division or the deliberation division determines that a certain standard should be revised, a staff inputs a standard number (or ID) of the standard as a target to be revised, via the standard number input section 9, and then, the present system operates. If a new standard is established, the same processing procedure as described above is carried out with respect to a standard similar to the new standard (e.g., the number of the similar standard is inputted). Then, deliberation request allocation can be executed with respect to the new standard.

At first, a standard number of a standard to be revised is inputted (step S1). The use result calculation section 4 then obtains a state of use concerning the standard from the state-of-use record DB 2 (step S2), and calculates a use result (for example, users and the number references [or the number of accesses]) (step S3).

The use result calculation section 4 calculates how many times a standard (for example, KA00001) has been referred to (the number of references), for every user ID. Further, the use result calculation section 4 totals the numbers of references for all user IDs, to calculate the use result.

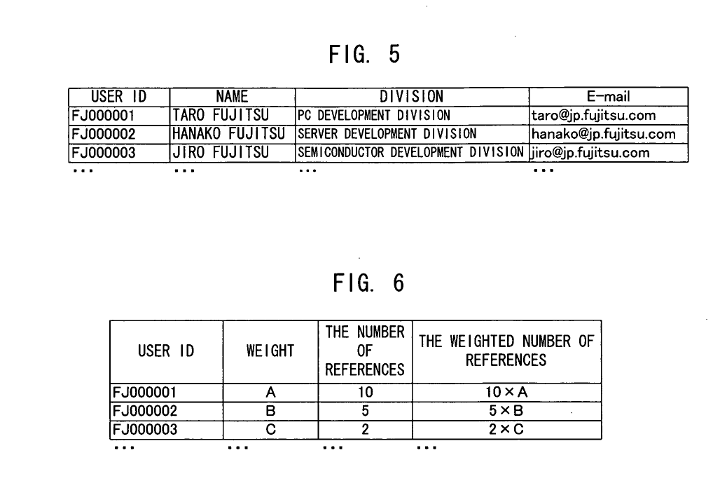

Next, if the total value is not smaller than a predetermined value, the standard revision determination section 5 determines that a revision of the standard should be executed (step S4, Y). The deliberation request allocation section 6 obtains user information from the user information management DB 3, and decides to issue a deliberation request to each of users who have referred to the standard a predetermined number of reference times or more. The deliberation request allocation section 6 prepares a deliberation request allocation table shown in FIG. 5 (step S5), and supplies the table to the deliberation request section 7. The deliberation request section 7 sends an electronic mail to each user in accordance with the allocation table shown in FIG. 5 (step S6). Otherwise, if the number of references (total value) does not exceed the predetermined value in step S4 (step S4, N), the standard is frozen (step S7), and for example, the standard operation server 200 stops access to the standard.

In case of establishing a new standard, deliberation request allocation is carried out with respect to a similar standard, as described above, and is regarded as allocation of a deliberation request for establishment of the new standard.

In the structure as described above, the use result calculation section 4 takes, as a use result, the total value which totals the numbers of references respectively obtained for all the user IDs, as shown in FIG. 4. However, as shown in FIG. 6, an importance level of a standard may be set for each user ID (division). Values as products (weighted values) obtained by multiplying the numbers of references by the weight coefficient of the importance level may be totaled and taken as a use result. At the time of deliberation, further weighting may be carried out with a deliberation right in majority decision or the like (for example, the weight of one vote in majority decision or the like) in accordance with the number of references or a weighted value. The deliberation request allocation section 6 is capable of preparing a deliberation request allocation table such that the deliberation right is sent to each of parties to be given a deliberation request.

A program to let a computer execute the steps described with reference to FIG. 3 may be stored as a deliberation request allocation program into recording media readable by computers. Then, the computer can then be let execute deliberation request allocation based on the deliberation request allocation system. According to the present invention, the recording media readable by the computer may include a portable storage medium such as a CD-ROM, flexible disk, DVD disk, magneto-optical disk, or IC card, a database storing a computer program, another computer and a database thereof, and transfer media on lines.

What is claimed is:

1. A deliberation request allocation system comprising:
a state-of-use obtaining section that obtains, as electronic data, a state of use including users of a standard and the numbers of uses of the standard;
a use result calculation section that calculates a use result of the standard, by use of electronic data, based on the state of use obtained by the state-of-use obtaining section; and
a deliberation request allocation section that decides and allocates a party to be given a deliberation request, who should attend a deliberation to revise the standard or to establish a new standard similar to the standard, by use of electronic data, based on the use result calculated by the use result calculation section.

2. The deliberation request allocation system according to claim 1, further comprising a determination section that determines whether the standard should be frozen without a deliberation or not, based on the use result calculated by the use result calculation section.

3. The deliberation request allocation system according to claim 1, wherein the deliberation request allocation section weights a deliberation right of the party to be given a deliberation request, based on the state of use.

4. The deliberation request allocation system according to claim 1, wherein the use result calculation section regards, as the use result, a total of the numbers of uses by all of the users, the numbers of uses being included in the state of use.

5. The deliberation request allocation system according to claim 1, wherein the use result calculation section weights the users, calculates weighted numbers of uses by the users, respectively, and regards a total of the weighted numbers of uses, as a use result.

6. The deliberation request allocation system according to claim 1, further comprising a deliberation request section that sends an attendance request for the deliberation, to the party to be given a deliberation request, who has been allocated by the deliberation request allocation section.

7. The deliberation request allocation system according to claim 6, wherein the deliberation request allocation section obtains user information from a user information management database that manages user information including the users, and lets the party to be given a deliberation request correspond to a destination address of the obtained user information.

8. A deliberation request allocation program that makes a computer execute allocation of a deliberation request, comprising:
a state-of-use obtaining step that obtains, as electronic data, a state of use including users of a standard and the numbers of uses of the standard;
a use result calculation step that calculates a use result of the standard, by use of electronic data, based on the state of use obtained by the state-of-use obtaining step; and
a deliberation request allocation step that decides and allocates a party to be given a deliberation request, who should attend a deliberation to revise the standard or to establish a new standard similar to the standard, by use of electronic data, based on the use result calculated by the use result calculation step.

9. The deliberation request allocation program according to claim 8, further comprising a determination step that determines whether the standard should be frozen without a deliberation or not, based on the use result calculated by the use result calculation step.

10. The deliberation request allocation program according to claim 8, wherein the deliberation request allocation step weights a deliberation right of the party to be given a deliberation request, based on the state of use.

11. The deliberation request allocation program according to claim 8, wherein the use result calculation step regards, as the use result, a total of the numbers of uses by all of the users, the numbers of uses being included in the state of use.

12. The deliberation request allocation program according to claim 8, wherein the use result calculation step weights the users, calculates weighted numbers of uses by the users, respectively, and regards a total of the weighted numbers of uses, as a use result.

13. The deliberation request allocation program according to claim 8, further comprising a deliberation request step that sends an attendance request for the deliberation, to the party to be given a deliberation request, who has been allocated by the deliberation request allocation step.

14. The deliberation request allocation program according to claim 13, wherein the deliberation request allocation step obtains user information from a user information management database that manages user information including the users, and lets the party to be given a deliberation request correspond to a destination address of the obtained user information.

15. A deliberation request allocation method in which a computer of a deliberation request allocation system is made execute allocation of a deliberation request, comprising:
a state-of-use obtaining step that obtains, as electronic data, a state of use including users of a standard and the numbers of uses of the standard;
a use result calculation step that calculates a use result of the standard, by use of electronic data, based on the state of use obtained by the state-of-use obtaining step; and
a deliberation request allocation step that decides and allocates a party to be given a deliberation request, who should attend a deliberation to revise the standard or to establish a new standard similar to the standard, by use of electronic data, based on the use result calculated by the use result calculation step.

16. The deliberation request allocation method according to claim 15, further comprising a determination step that determines whether the standard should be frozen without a deliberation or not, based on the use result calculated by the use result calculation step.

17. The deliberation request allocation method according to claim 15, wherein the deliberation request allocation step weights a deliberation right of the party to be given a deliberation request, based on the state of use.

18. The deliberation request allocation method according to claim 15, wherein the use result calculation step regards, as the use result, a total of the numbers of uses by all of the users, the numbers of uses being included in the state of use.

19. The deliberation request allocation method according to claim 15, wherein the use result calculation step weights the users, calculates weighted numbers of uses by the users, respectively, and regards a total of the weighted numbers of uses, as the use result.

20. The deliberation request allocation method according to claim 15, further comprising a deliberation request step that sends an attendance request for the deliberation, to the party to be given a deliberation request, who has been allocated by the deliberation request allocation step.
